(19) United States
(12) Patent Application Publication
(10) Pub. No.: US 2014/0313584 A1
(43) Pub. Date: Oct. 23, 2014

(54) DIFFRACTIVE OPTICAL ELEMENT AND IMAGING DEVICE AND ILLUMINATING DEVICE USING SAME

(71) Applicant: Panasonic Corporation, Osaka (JP)

(72) Inventors: Yasuyuki Hanada, Fukuoka (JP); Tsuguhiro Korenaga, Osaka (JP); Yuka Okada, Hyogo (JP)

(73) Assignee: PANASONIC CORPORATION, Osaka (JP)

(21) Appl. No.: 14/356,453

(22) PCT Filed: Oct. 30, 2012
(86) PCT No.: PCT/JP2012/006960

§ 371 Date: May 6, 2014

(30) Foreign Application Priority Data
Nov. 9, 2011 (JP) 2011-245457

(51) Int. Cl. G02B 5/18

(52) U.S. Cl. CPC G02B 5/1876
USPC 359/571

(57) ABSTRACT

To provide a highly workable diffractive optical element which realizes a high refractive index and a low wavelength dispersiveness well balanced with each other and which exhibits high heat resistance and high endurance against temperature changes, a diffractive optical element includes a base member including a diffraction grating formed on a surface thereof and a protective film provided on the surface of the base member where the diffraction grating is formed, wherein the base member is composed of a silsesquioxane resin material or a dendrimer material which has a first refractive index and a first Abbe number and wherein the protective film is composed of a silicone resin material which has a second refractive index smaller than the first refractive index and a second Abbe number smaller than the first Abbe number.

### TECHNICAL FIELD

The present invention relates to a diffractive optical element (diffractive optical lens) which converges or diverges light using diffraction phenomena and an imaging device and an illuminating device using the same.

### BACKGROUND ART

In recent years optoelectronics has been attracting attention as key technology to realize high-speed information communication, a variety of smaller and lighter electronic devices, etc. and optical materials to realize them are under rapid development.

Conventionally, inorganic materials such as optical glass have been widely used as optical materials. However, inorganic optical materials are difficult to process and inherently have a problem that it is difficult to achieve low-cost mass production of optical components, which are becoming smaller and more complex, by use of inorganic optical materials.

On the other hand, organic materials, mainly resins, are highly workable and thus can be produced at low cost, and also are light in weight. Thus, organic materials are expected to advance optoelectronics technology in the future and the development thereof is being accelerated recently.

One of the problems of organic optical materials is that, when optical components are composed only of organic optical materials, the refractive indices are not sufficiently high. Another is that only a small number of organic optical materials have a refractive index balanced with their wavelength dispersiveness. It is known that the refractive index nmD at D-line (wavelength 589 nm) and Abbe number νm at D-line, where Abbe number represents wavelength dispersiveness, generally satisfy (Eq. 1) shown below for resin materials most commonly used as organic optical materials (see Non Patent Document 1). It is to be noted that since the wave lengths of D-line and d-line (wavelength 587 nm) are very close, the refractive indices at D-line and d-line of each material may be considered to be substantially the same.

1.66−0.004νm≦nmD≦1.8−0.005νm (Eq. 1)

The problems that resins do not have a sufficiently high refractive index and that there are only a few materials having a refractive index balanced with wavelength dispersiveness in turn cause a problem that, when forming a lens, for example, as an optical component, a satisfactory characteristic cannot be obtained due to chromatic aberration and field curvature. In the case of a solid-state image sensor including an optical waveguide as its optical component, a sufficient difference in refractive indices between the optical waveguide and peripheral material thereof may not be obtained, and this results in a decrease in light collection efficiency.

To solve these problems, it is considered, for example, to prepare an organic optical material having a high refractive index by dispersing inorganic fine particles in a resin for forming a base member and to form an optical component by use of this material.

Patent Document 1 discloses a method for obtaining an optical component made of organic optical material which exhibits a high refractive index and a low wavelength dispersiveness, wherein the optical component is formed of a resin composition obtained by dispersing fine particles of alumina, yttrium oxide, etc. in a transparent base resin such as methacrylate resin.

Patent Documents 2-4 disclose methods for forming optical components made of a thermoplastic resin composition obtained by dispersing fine particles of titanium oxide or zinc oxide in a thermoplastic resin which has an optical characteristic of a certain level or higher.

In addition, Patent Document 5 discloses a diffraction grating lens composed of a lens base body with a diffraction grating formed thereon and an optical adjustment film made of resin and provided on the lens base body. Patent Document 5 discloses that the optical adjustment film made of an optical material having a refractive index and a refractive index dispersion different from those of the lens base body is provided on a surface of the lens base body having the diffraction grating formed thereon. Patent Document 5 describes that according to such a structure, it is possible by setting the refractive index of the base member formed with the diffraction grating and the refractive index of the optical adjustment film formed to cover the diffraction grating such that they satisfy a predetermined condition, to reduce wavelength dependency of a diffraction efficiency and to reduce diffracted light of undesired orders, thereby suppressing flair caused by the diffracted light of undesired orders.

### PRIOR ART DOCUMENT(S)

### Patent Document(s)

Patent Document 1: JP 2001-183501 A
Patent Document 2: JP 2003-073559 A
Patent Document 3: JP 2003-073563 A
Patent Document 4: JP 2003-073564 A
Patent Document 5: JP H09-127321 A

### Non Patent Document(s)

Non Patent Document 1: Fumio Ide “Kikan Kagaku Sosetsu No. 39 Refractive Index Control of Transparent Polymers,” The Chemical Society of Japan (ed.), Nov. 10, 1998, page 9, FIG. 2

### BRIEF SUMMARY OF THE INVENTION

### Task to be Accomplished by the Invention

However, in the method disclosed in Patent Document 1, since alumina with a refractive index of 1.76 at d-line (wavelength 587 nm) (hereinafter referred to as “d-line refractive index”) is dispersed in the base resin, it is difficult in principle to obtain a resin composition with a high refractive index. It is to be noted that Patent Document 1 also discloses a method for dispersing inorganic fine particles other than alumina in the base resin, and describes that, in this case, anomalous dispersion material such as infrared absorbing dye is further dispersed to achieve a sufficiently high Abbe number (namely a low wavelength dispersiveness). Additionally, in the methods disclosed in Patent Documents 2-4, since titanium oxide or zinc oxide having a high wavelength dispersiveness (both having Abbe number of 12) is employed to form inorganic fine particles to be dispersed in the base resin, if the concentration of the dispersed inorganic particles is increased to obtain a resin composition with a high refractive index, the wavelength dispersiveness greatly increases, whereby it is difficult to obtain a resin composition which has both a high refractive index and a low wavelength dispersiveness.

A highly workable optical material only composed of a low cost resin composition is suitable for a diffraction grating lens for use in portable phones, compact cameras, car-mounted cameras, security cameras, etc. and especially suitable for a white light diffraction lens which has substantially the same diffractive index over the entire wavelength region of visible light. However, it is sometimes demanded to mount such a white light diffraction lens onto an electronic substrate via a member for holding the white light diffraction lens, along with other electronic components such as an image sensor, and to carry out reflow soldering in that state. In this way, the white light diffraction lens can be secured onto the electronic substrate together with the other electrical components. Therefore, it is desirable that the white light diffractive lens can endure an environment of a reflow soldering furnace whose temperature exceeds 200° C. at the highest.

However, it is difficult for the resin composition or structure disclosed in Patent Documents 1-5 to endure such a high temperature environment.

The object of the present invention is to provide a diffractive optical element which realizes a high refractive index and a low wavelength dispersiveness well balanced with each other, which is highly workable and which exhibits high heat resistance and high endurance against temperature changes.

### Means to Accomplish the Task

To achieve the above-described object, a diffractive optical element according to the present invention includes: a base member including a diffraction grating formed on a surface thereof and a protective film provided on the surface of the base member where the diffraction grating is formed, wherein the base member is composed of a silsesquioxane resin material or a dendrimer material which has a first refractive index and a first Abbe number and wherein the protective film is composed of a silicone material which has a second refractive index smaller than the first refractive index and a second Abbe number smaller than the first Abbe number.

### EFFECT OF THE INVENTION

According to the diffractive optical element of the present invention, it is possible to obtain a highly workable diffractive optical element which exhibits high heat resistance and endurance against temperature changes and in which a resin material which has a high refractive index and a low wavelength dispersiveness and another resin material which has a low refractive index and a high wavelength dispersiveness are well balanced with each other.

### BRIEF DESCRIPTION OF THE DRAWINGS

FIG. 1 is an explanatory view showing a convex lens employing a diffractive optical element according to the first embodiment of the present invention.

FIG. 2 is a graph showing a relationship between the Abbe number and refractive index of resin materials according to the first embodiment of the present invention.

FIG. 3 is an explanatory view illustrating a manufacturing process of a base member including a diffraction grating in the diffractive optical element of the first embodiment of the present invention.

FIG. 4 is an explanatory view illustrating a process of forming a protective film on the base member having the diffraction grating formed thereon in the diffractive optical element of the first embodiment of the present invention.

FIG. 5 is an explanatory view showing a variation of the diffractive optical element of the first embodiment of the present invention.

FIG. 6 is a perspective view of an imaging device including a built-in diffractive optical element according to the second embodiment of the present invention.

FIG. 7 is a cross-sectional view showing an internal structure of a camera unit according to the second embodiment of the present invention.

FIG. 8 is an overall structural view of an endoscope including an illuminating device according to the third embodiment of the present invention.

FIG. 9 is a side view showing an internal structure of a distal end portion of an insertion portion of the endoscope according to the third embodiment of the present invention.

FIG. 10 is a perspective view showing the internal structure of the distal end portion of the insertion portion of the endoscope according to the third embodiment of the present invention.

FIG. 11 is a cross sectional view showing the internal structure of the distal end portion of the insertion portion of the endoscope according to the third embodiment of the present invention.

FIG. 12A is an explanatory view showing a mode of illumination provided by the endoscope according to the third embodiment of the present invention.

FIG. 12B is an explanatory view showing an example for comparison with the illumination shown in FIG. 12A.

FIG. 13 is an explanatory view showing an example of diffusing effect of illumination light caused by diffraction.

### EMBODIMENTS FOR CARRYING OUT THE INVENTION

### First Embodiment

The present invention will be described in detail below with reference to the drawings.

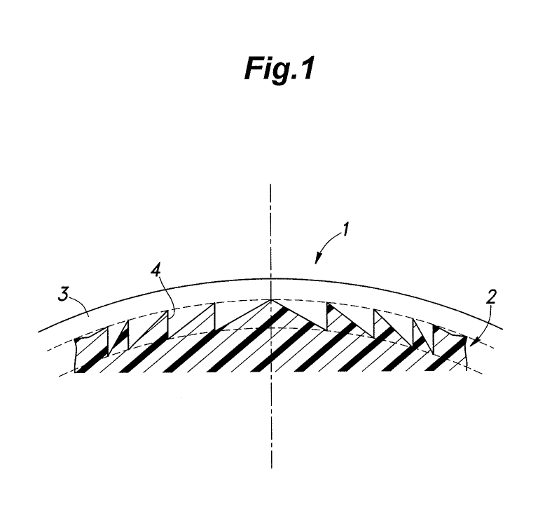

FIG. 1 is an explanatory view showing a convex lens (diffraction optical lens) employing a diffractive optical element according to the first embodiment of the present invention. In the convex lens 1 shown in FIG. 1, a base member 2 is formed of a silsesquioxane resin material and a protective film 3 is formed of a silicone resin material and contacts the base member 2. A diffraction grating (blazed diffraction grating) 4 is formed concentrically with a center of the base member 2 at an interface between the base member 2 and the protective film 3. CE indicates an optical axis of the convex lens 1.

The protective film 3 has a function of physically protecting the diffraction grating 4 formed on the base member 2 as well as a function as an optical adjustment film. Namely, it is possible, for example, to decrease wavelength dependency of diffraction efficiency by properly setting the refractive index of the base member 2 having the diffraction grating 4 formed thereon and the refractive index of the protective film 3 formed to cover the diffraction grating 4.

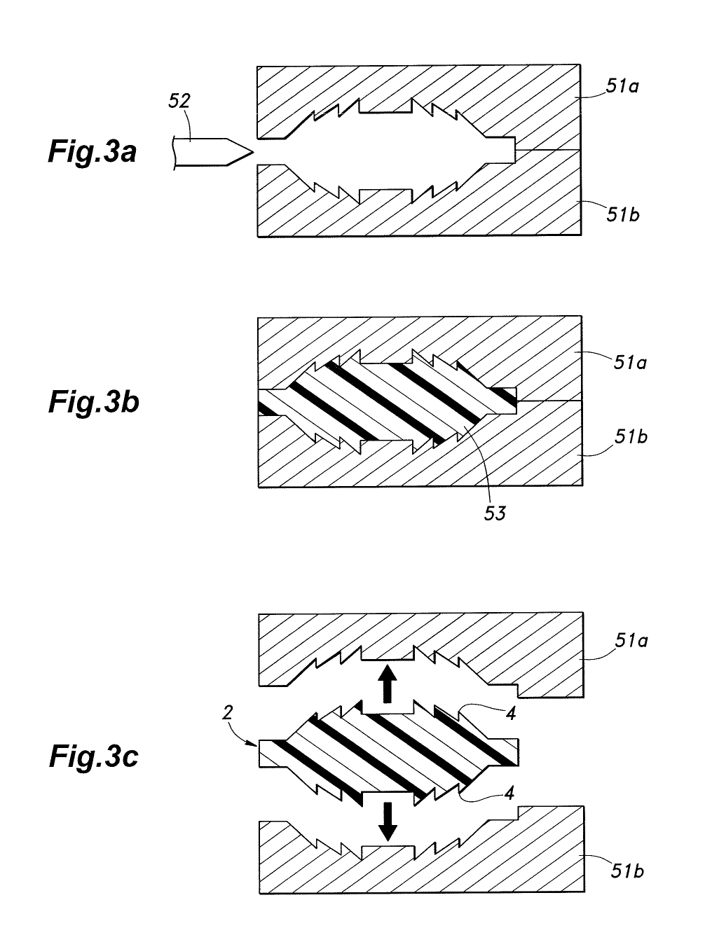

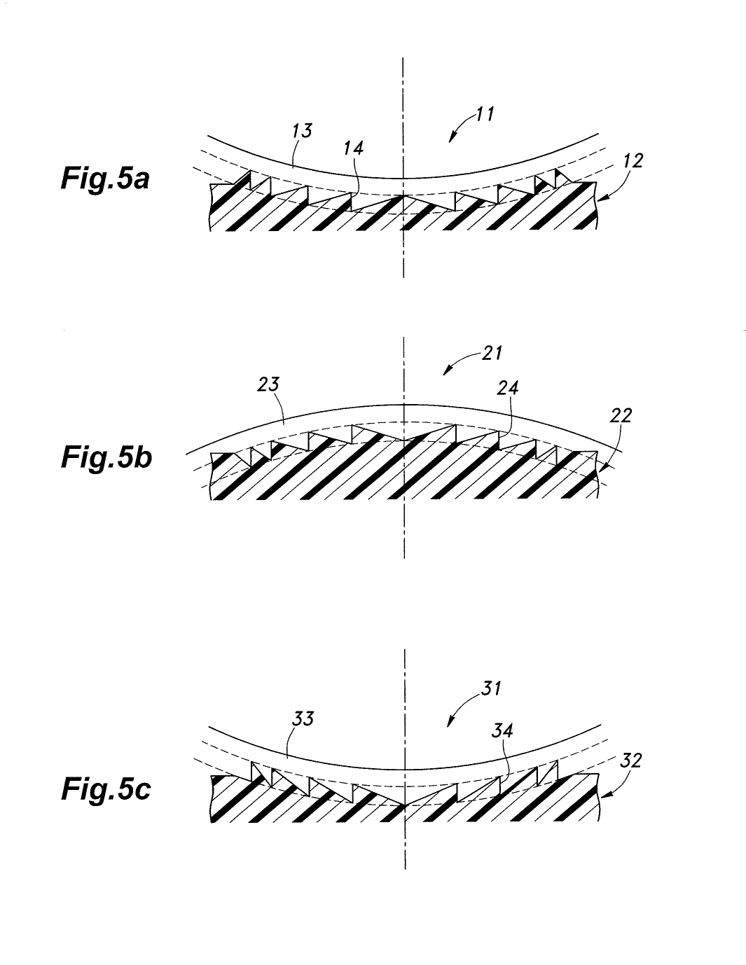

In addition, dotted lines in the drawing are lines which respectively connect upper vertices and lower vertices of saw tooth-like grooves seen in a cross section of the diffraction grating 4 (This is also the case in FIG. 5). While a width between the upper and lower vertices is shown to be very large in FIG. 1, this is actually set to be a few to about 30 μm as described below (This is also the case in FIGS. 3, 4 and 5).

A silsesquioxane resin herein is a general term for organic silicon polymers which have an organic substituent on silicons (general formula RSiO_{1.5}), and this resin material is described in detail in Seiichiro Tajima (Shinseihin Kihatsu Kenkyuujo) “Silsesquioxane Derivatives ‘SQ Series’” in: To a Gosei Kenkyu Nenpo Trend 2004 No. 7, page 37-41, for example. It is to be noted that FIG. 1 only shows one surface of the convex lens 1 in a direction of the lens optical axis, and the opposite lens surface, which is not shown in the drawing, generally does not have the diffraction grating 4 and protective film 3 of the first embodiment and is formed as a convex or concave lens surface which may be spherical or aspherical and which has a usual refractive power. However, it is also possible to form the diffraction grating 4 on each of the principal surfaces in the direction of the lens optical axis.

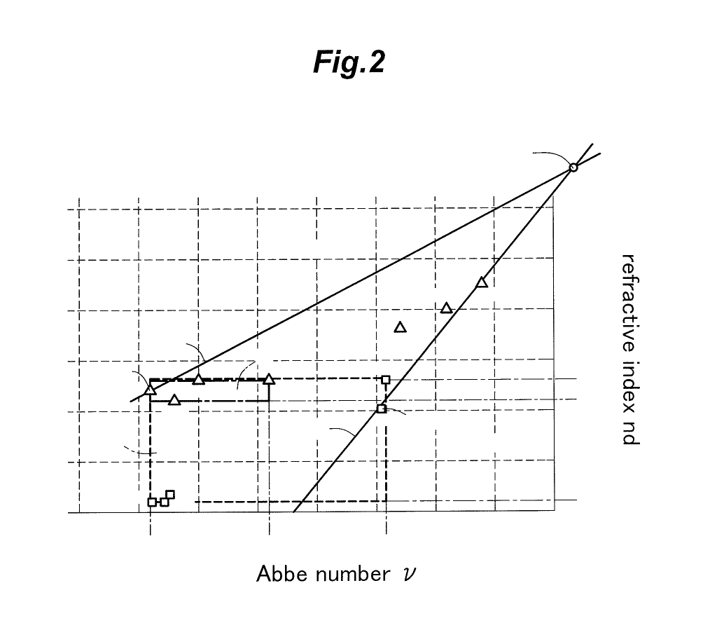

FIG. 2 is a graph showing a relationship between the Abbe number and refractive index of resin materials according to the first embodiment of the present invention. In FIG. 2, horizontal and vertical axes indicate the Abbe number ν and refractive index nd, respectively. Lines A and B are defined as follows.

nd=−0.0061ν+1.8507 Line A:

nd=−0.0141ν+1.9949 Line B:

Line A is obtained by plotting, of points represented by combinations of the Abbe number ν and refractive index nd of silsesquioxane resin materials that satisfy conditions for ηm(λ) and d based on (Eq. 2)-(Eq. 4) described below, points each associated with a minimum refractive index for varying Abbe number. Similarly, line B is obtained by plotting points each associated with a maximum refractive index nd for varying Abbe number of silicone resin materials.

In the first embodiment, an average value of a diffraction efficiency based on the below equations (Eq. 2) and (Eq. 3) for calculating a diffraction efficiency ηm(λ) becomes 80% or more for any combination of a silsesquioxane resin material having a refractive index substantially on line A or in a region higher than line A and a silicone resin material having a refractive index substantially on line B or in a region lower than line B. Further, blaze d defined by (Eq.3) becomes 30 μm or less for certain combinations.

ηm(λ)=[sin{π(φ(λ)−m}/{π(φ)(λ)−m}]² (Eq. 2)

φ(λ)={d*|n1(λ)−n2(λ)|/λ} (Eq. 3)

d=|0.588/(n1−n2)| (Eq. 4)

In the above equations, λ represents a wavelength of light entering the diffractive optical element, which herein is visible light whose wavelength is 400 nm to 700 nm. The variable m in (Eq. 2) represents an order of diffracted light and m is equal to 1 for the first order diffracted light. It is to be noted that in the first embodiment, the diffraction efficiency is calculated for m=1 because a main purpose in the first embodiment is to ensure a sufficient diffraction efficiency for the first order diffracted light. It is also to be noted that in this embodiment the first order diffraction efficiency based on the equation for calculating the diffraction efficiency ηm(λ) is required to be 80% or more because a diffraction efficiency practical for an imaging lens is generally 80% or more.

The value “0.588”(μm) in (Eq. 4) is the wavelength of d-line and is generally employed as a central wavelength of visible light. This wavelength is adopted because the diffractive optical element of the first embodiment is designed to have a lens effect over the entire wavelength region of visible light. However, other values may be adopted as the central wavelength depending on an application of the diffractive optical element. If the diffractive optical element is used mainly for infrared region, for example, a central wavelength most appropriate for that region may be adopted.

In FIG. 2, triangles indicate the distribution of currently available silsesquioxane resin materials and squares indicate the distribution of currently available silicone resin materials. The inventors found a combination of resin materials most appropriate for the diffractive optical element from among combinations of the silsesquioxane resin materials in region C and silicone resin materials in region D. This combination consists of SQ1 at point E as the silsesquioxane resin material and SC4 at point F as the silicone resin material.

The silsesquioxane resin material SQ1 adopted in the first embodiment has the Abbe number and refractive index belonging to region C shown in FIG. 2, and has, for example, the Abbe number and refractive index corresponding to point E. The silicone resin material SC4 has the Abbe number and refractive index belonging to region D and has, for example, the Abbe number and refractive number corresponding to point F.

SILPLUS (registered trademark) available from Nippon Steel & Sumikin Chemical Co., Ltd. may be employed as SQ1, for example. In the first embodiment, SILPLUS having a refractive index nd of about 1.52 and an Abbe number of about 54 is used. The refractive index nd of SILPLUS may be chosen in the range of 1.51-1.53 and the Abbe number of SILPLUS in the range of 44-54 (in the range S1 shown in the drawing). However, not all commercially available SILPLUS may be used due to the above-mentioned restriction in relation to line A. (Silsesquioxane resin material having a refractive index substantially on line A or in the region higher than line A should be chosen.)

On the other hand, IVS5022 available from Momentive Performance Materials Inc. may be employed as the silicone resin material SC4, for example. In the first embodiment, IVS5022 having a refractive index of 1.50 and an Abbe number of 34.7 is used. The refractive index nd of IVS5022 may be chosen in the range of 1.41-1.53 and the Abbe number of IVS5022 in the range of 34.2-54 (in the range S2 shown in the drawing). However, not all commercially available IVS5022 may be used due to the above-mentioned restriction in relation to line B. (Silicone resin materials having a refractive index substantially on line B or in the region lower than line B should be chosen.)

If the Abbe number ν and refractive index nd of SQ1 and SC4 are put into (Eq. 2)-(Eq. 4) described above to calculate the diffraction efficiencies ηm(λ) for visible light of wavelength of 400-700 nm at 1 nm intervals, and then calculate an average of thus-obtained diffraction efficiencies ηm(λ), the average of the diffraction efficiencies will be about 98%, which shows that the combination has a very high diffraction efficiency.

The characteristics of a diffraction optical lens composed of a combination other than SQ1 and SC4 will be explained below. There are silsesquioxane resin materials having the Abbe numbers and refractive indices corresponding to, for example, the positions of SQ2-SQ7, which are present on the lower side of line A. Also, there are silicone resin materials having the Abbe numbers and refractive indices corresponding to, for example, the positions of SC1-SC3 and SC5, which are present on the upper side of line B. If a combination is chosen from them to ensure an appropriate difference in the refractive indices to form a diffraction optical lens, the diffraction efficiency thereof will be reduced in a specific wavelength region. In other words, aberration will occur at a specific color (spectrum), and thus the lens cannot be used as a white light lens.

Resin materials other than silsesquioxane are present in region C and resin materials other than silicone are present in region D. However, if a diffraction optical lens is formed of these materials, since their heat resistance is low in general, the lens cannot endure a high-temperature environment such as that in which reflow soldering is performed.

According to (Eq. 4), it can be appreciated that the depth d of the groove of the diffraction grating 4 in the direction of the optical axis CE is 29.4 μm for the combination of SQ1 and SC4.

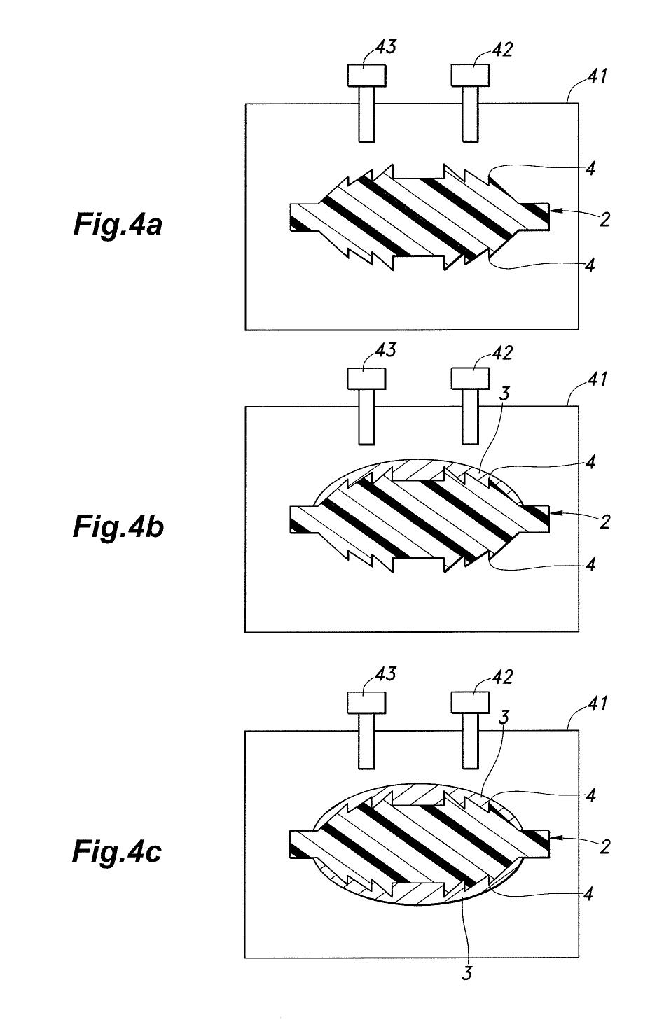

FIG. 3 is an explanatory view illustrating a manufacturing process of the base member 2 including the diffraction grating 4 in the convex lens 1 of the first embodiment of the present invention. It is to be noted that FIG. 3 illustrates a manufacturing process of a structure of the convex lens 1 including diffraction gratings formed on both sides thereof. (This is also the case in FIG. 4.)

First, as shown in FIG. 3(a), molds 51a and 51b each defining the shape of the diffraction grating 4 are prepared. Then, as shown in FIG. 3(b), uncured silsesqioxane resin material 53 is injected into the molds 51a and 51b from a vacuum injection nozzle 52 (Refer to FIG. 3(a).) to fill the molds. Thereafter, as shown in FIG. 3(c), the molds 51a and 51b are removed, whereby the base member 2 having the diffraction gratings 4 formed on both surfaces is obtained. It is to be noted that the manufacturing process of the base member 2 made of silsesquioxane is not limited to a molding process that uses molds, but may include a process of forming grooves by laser machining, for example, in the part where the diffraction grating 4 is to be provided.

FIG. 4 is an explanatory view illustrating a process of forming protective films 3 on the base member 2 having the diffraction gratings 4 formed thereon in the convex lens 1 of the first embodiment of the present invention.

First, as shown in FIG. 4(a), the base member 2 is placed in an air-tight vessel 41 including vacuum injection nozzles 42 and 43 and the pressure inside the air-tight vessel 41 is decreased. It is not necessary to lower the pressure inside the air-tight vessel 41 as is needed in vacuum processes such as vacuum vapor deposition, CVD, etc. Sufficient effects may be obtained with pressure from about 1 Pa to about 5000 Pa. The pressure is preferably equal to or smaller than 100 Pa.

Next, as shown in FIG. 4(b), coating fluid (solvent including silicone resin material) for forming the protective film 3 of silicone resin material is applied from the vacuum injection nozzle 42 onto the surface of the base member 2 provided with the shape of the diffraction grating 4 in the air-tight vessel 41 with reduced pressure. Subsequently, by increasing the pressure in the air-tight vessel 41 back to the pressure prior to the pressure reduction, air bubbles are removed from the coating fluid to bring the coating fluid into tight contact with the microstructure of the diffraction grating 4, so that the protective film 3 is formed to cover the entirety of the diffraction grating 4. Then, as shown in FIG. 4(c), the base member 2 is reversed, the pressure in the air-tight vessel 41 is reduced again, and the coating fluid (solvent including silicone resin material) for forming the protective film 3 of silicone resin material is applied from the vacuum injection nozzle 42 onto the surface of the base member 2 provided with the shape of the diffraction grating 4. Then, the pressure in the air-tight vessel 41 is increased to form the protective film 3.

Thereafter, the convex lens 1 including the base member 2 with the protective films 3 formed thereon is taken out of the air-tight vessel 41, and a cure treatment for removing solvent from the coating fluid is performed to obtain the finished convex lens 1. The cure treatment may be carried out by light curing, heat curing, drying process, etc.

If the grooves of the diffraction grating 4 have a depth of 30 μm or more in the base member 2 produced in the foregoing manufacturing process, leakage of light through surfaces parallel to the entering and emitting direction of light (optical axis CE) increases (refer to FIG. 1), resulting in occurrence of undesired light which does not contribute to image formation. Therefore, the depth of the grooves of the diffraction grating 4 is preferably smaller than 30 μm. In this regard, the above-described value d of 29.4 μm of the depth of the grooves of the diffraction grating 4 is near the limit for realizing the function of the diffraction grating 4.

It is to be noted that, in a case where the resin material with a higher refractive index in the above-described combination of the resin materials is a silsesesquioxane resin having a refractive index nd of 1.52, if the resin material with a lower refractive index (silicone resin material) in the combination has a refractive index nd lower than 1.50, the depth d of the grooves of the diffraction grating 4 becomes greater than 30 μm. Therefore, the refractive index nd of 1.50 may be considered practically a lower limit of the refractive index of the resin materials to be adopted in the first embodiment of the present invention. In other words, each resin material adopted needs to have a refractive index nd equal to or greater than 1.50.

Now, an explanation will be continued with reference to FIG. 2 again. Lines A and Bin FIG. 2 intersect each other at point Q (ν, nd)=(18.025, 1.741). This means that at point Q, both resin materials on lines A and B have the same characteristics such as a refractive index. However, when both resin materials have the same characteristics, a high refractive index and a low wavelength dispersiveness cannot be achieved even if the structure shown in FIG. 1 is adopted. This is because the resulting structure is no different from a lens having a usual refractive power composed only of the same resin material. Therefore, this point (ν, nd)=(18.025, 1.741) defines a right boundary of each of lines A and B shown in FIG. 2.

In addition to being composed of a combination of a silsesqioxane resin material in region C and a silicone resin material in region D as described above, the diffractive optical element of the present invention needs to substantially satisfy the following conditions. Namely, the silsesquioxane resin material in region C is further required to be in a region where (Eq. 5) below is satisfied.

Abbe number ν>18.025 (Eq. 5)

Also, the silicone resin material in region D is further required to be in a region where (Eq. 6) below is satisfied.

refractive index nd<1.741 (Eq. 6)

It is to be noted that the above-described combination of point E (SQ1) and point F (SC4) provides a sufficiently high diffraction efficiency by itself. This makes it unnecessary to further increase the diffraction efficiency by dispersing in the protective film nanometer-size inorganic fine particles such as zirconium dioxide disclosed in the prior art, and thus, defects such as agglomeration of inorganic fine particles and clouding of the protective film do not occur. Further, decrease of adhesion force between the base member 2 and protective film 3 caused by addition of the inorganic fine particles can be avoided.

It is generally known that glass transition temperatures Tg is 200° C. or more for silicone resin materials and 300° C. or more for silsesquioxane resin materials, and thermal expansion coefficient is 2.8×10⁻⁴ for silicone resin materials and 0.9-1.1×10⁴ for silsesquioxane resin materials. Thus, the glass transition temperature Tg is high and the thermal expansion coefficient is small (on the order of 10⁴) for both kinds of materials. This makes mounting by reflow soldering possible to thereby achieve a higher production efficiency without causing thermal deformation of the materials themselves or peeling of the protective film 3 from the base member 2 due to a difference in thermal expansion coefficients of the materials. Further, a storage temperature is dramatically improved. Since both kinds of resin materials are highly workable, it is possible to carry out mass production at low cost and in a short period of time by the manufacturing process using molds as described above.

In the first embodiment described above, the convex lens 1 including the base member 2 made of a silsesquioxane resin material and the protective film 3 made of a silicone resin material has been explained. This structure can achieve a balance between the first resin material (silsesquioxane resin material) and the second resin material (silicone resin material) to realize a high performance convex lens, wherein the first resin material has a high refractive index (high refractive index nd and high Abbe number ν) and a low wavelength dispersiveness (high Abbe number) and the second resin material has a low refractive index (low refractive index relative to that of the first resin material and low Abbe number) and a high wavelength dispersiveness (low Abbe number relative to that of the first resin material).

As described above, the diffractive optical element of the first embodiment includes the base member 2 including a diffraction grating 4 formed on a surface thereof and the protective film 3 formed on the surface of the base member 2 where the diffraction grating 4 is formed, wherein the base member 2 is composed of a silsesquioxane resin material which has a first refractive index (e.g. nd=1.52) and a first Abbe number (e.g. ν=54) and wherein the protective film 3 is composed of a silicone resin material which has a second refractive index (e.g. nd=1.50) smaller than the first refractive index and a second Abbe number (e.g. ν=34.7) smaller than the first Abbe number.

FIG. 5 is an explanatory view showing a variation of the diffractive optical element of the first embodiment of the present invention. The present invention may be practiced without being limited to the convex lens 1 described above. FIG. 5 (a) shows a concave lens 11 including a base member 12 made of a silsesquioxane resin material and a protective film 13 made of a silicone resin material. FIG. 5 (b) shows a convex lens 21 including a base member 22 made of a silicone resin material and a protective film 23 made of a silsesquioxane resin material. FIG. 5 (c) shows a concave lens 31 including a base member 32 made of a silicone resin material and a protective film 33 made of a silsesquioxane resin material.

As described above, the variation of the diffractive optical element of the first embodiment includes diffractive optical elements in which the base member 2 including a diffraction grating 4 formed on a surface thereof is composed of a silicone resin material, and the protective film 3 formed on the surface of the base member 2 where the diffraction grating 4 is formed is composed of a silsesquioxane resin material, wherein the silicone resin material has a second refractive index (e.g. nd=1.50) and a second Abbe number (e.g. ν=34.7) and the silsesquioxane resin material has a first refractive index (e.g. nd=1.52) greater than the second refractive index and a first Abbe number (e.g. ν=54) greater than the second Abbe number (refer to FIGS. 5 (b) and 5(c)).

As explained above, the diffractive optical element of the present invention is not limited to a convex lens but may be a concave lens. Further, the resin materials constituting the base member and the protective film may be interchanged. It is to be noted, however, that higher workability is generally obtained if the base member is composed of a silsesquioxane resin material has a high viscosity in the monomer phase prior to polymerization and the protective film is composed of a silicone resin material which has a relatively low viscosity in the monomer phase prior to polymerization. It is also to be noted that the shape of the grooves of the diffraction grating 4 (14, 24, 34) is different depending on which of the base member 2 and the protective film 3 is made of a silsesquioxane resin material and which of them is made of a silicone resin material. This is because the refractive indices and Abbe numbers of the two materials are different.

### Modification of the First Embodiment

Next, a diffractive optical element according to a modification of the first embodiment of the present inventions will be explained. This modification differs from the first embodiment in that a dendrimer material is used as a material for forming the above-described lens instead of the silsesquioxane resin material. It is to be noted that the modification is similar to the first embodiment except for otherwise noted in the following description.

As the dendrimer material, any known dendrimer material that can realize desired characteristics (refractive index, Abbe number, etc.) may be adopted. Such a materials may include a curable resin composition comprising an aromatic ester (meth)acrylate dendrimer and a polymerization initiator as indispensable components thereof, wherein the aromatic ester (meth)acrylate dendrimer is expressed by the following general formula and includes an aromatic compound with a plurality of carboxyl groups as a central component and an aromatic compound with one hydroxyl group and two carboxyl groups as a branch component, as is disclosed in JP H11-60540A, for example.

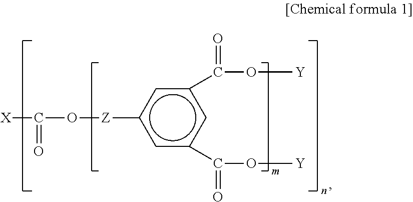

where m is a number of repetitions from 1 to 10 and n is an integer from 3 to 6.

In the above formula, the central part X is an aromatic residue derived from a polycarboxylic acid having 6 to 20 carbon atoms or its derivative, and is preferably an aromatic residue derived from an aromatic compound, etc. having any one of the scaffolds shown below.

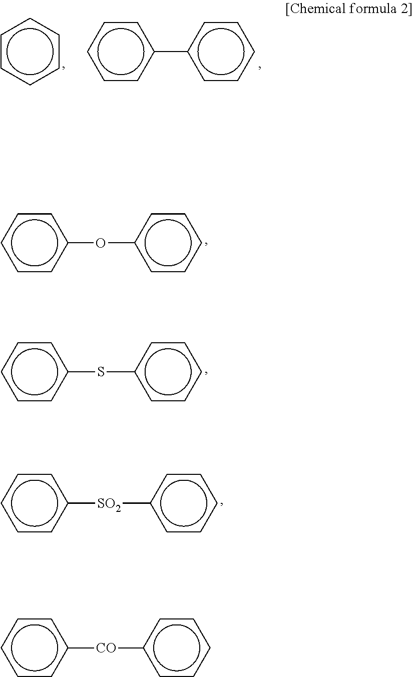

Y is an organic group having 6 to 20 carbon atoms and including an acryl group or a methacryl group, and is indicated by the following general formula.

(CH₂═CR—COO)ₙ-Q-O—

, where Q is a hydrocarbon group having 1 to 17 carbons, R is a hydrogen or a methyl group and n is an integer from 1 to 5.

Further, Z represents a direct bonding or an aromatic residue having 6 to 20 carbon atoms, and is preferably one of the following.

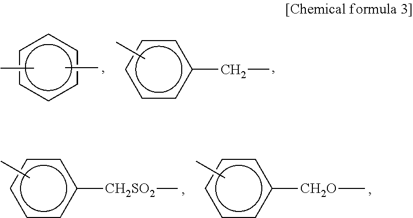

By using such an aromatic ester (meth)acrylate dendrimer, it is possible to obtain a resin material which has a refractive index nd in the range of 1.525-1.620 and Abbe number ν in the range of 54-26. Commercially available such resin materials include, for example, ESDRIMER (registered trademark) L series ((nd, ν)=(1.525, 54), (1.582, 33), (1.602, 29), (1.620, 26)) from Nippon Steel & Sumikin Chemical Co., Ltd. Particularly, the resin having a refractive index nd of about 1.525 and Abbe number ν of about 54 has characteristics similar to those of the silsesqioxane resin material at point E in FIG. 2 described above (SQ1). This resin material has an excellent heat resistance and may be employed in a high temperature environment such as that in which reflow soldering is performed.

### Second Embodiment

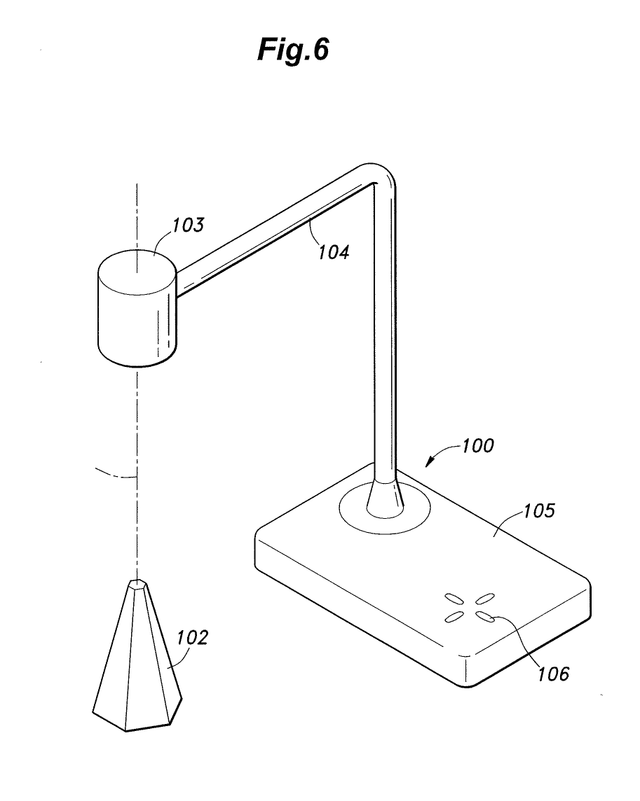

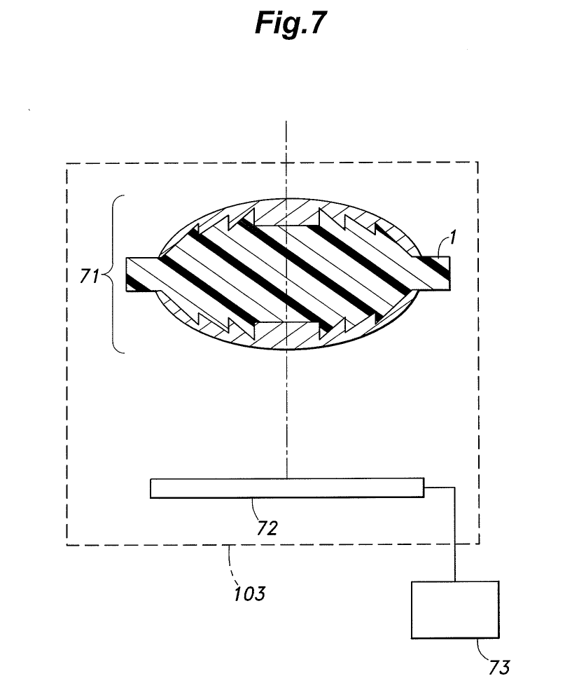

FIG. 6 is a perspective view of an imaging device 100 including a built-in diffractive optical element according to the second embodiment of the present invention. FIG. 7 is a cross-sectional view showing an internal structure of a camera unit 103 according to the second embodiment of the present invention. In the following, the imaging device of the second embodiment of the present invention will be described in detail with reference to FIGS. 6 and 7.

The imaging device 100 according to the second embodiment is configured to take an image of an object 102 (which is a substantially hexagonal pyramid shaped three-dimensional object in the present example). A plurality of pieces of acquired image data may be displayed on a projector, etc. or may be transferred to a PC (personal computer), etc. (not shown) so that the image data may be processed.

The imaging device 100 is preferably used as a document camera or a scanner for “book scanning,” which is rapidly becoming popular recently. In addition, since the diffractive optical element of the present invention has reduced resolution degradation in a peripheral part thereof, the imaging device 100 can be used as a surveillance camera having no movable part, that is to say, as an omnidirectional camera. Furthermore, since the imaging device 100 achieves both compact size and improved performance, the device 100 is also suitable as a camera in a portable phone, a car-mounted camera or a medical camera.

As shown in FIG. 6, the imaging device 100 includes a camera unit 103 configured to take an image of the object 102 and a stand unit 105 which includes an arm 104 for holding the camera unit 103. The stand unit 105 includes a plurality of operation buttons for a user to input operation commands for image taking, etc. In addition, the imaging device 100 is capable of transmitting and receiving image data and various control signals to and from an image processing device via a communication control unit and an external interface (not shown in the drawings).

As shown in FIG. 7, provided in an interior of the camera unit 103 are an image sensor 72 composed of a CMOS (Complementary Metal Oxide Semiconductor), a CCD (Charge Coupled Device Image Sensor), etc. and an operation circuit 73 which generates an object image from information detected by the image sensor 72. In addition, an optical system 71 including the convex lens 1 having a structure selected from those described in detail in connection with the first embodiment is disposed above the image sensor 72 (Note that the vertical direction in FIG. 7 is inverted from that in FIG. 6.). The structure of the optical system 71 is not limited to the one shown herein, and various modifications are possible in accordance with optical characteristics required for the imaging device 100, such that the optical system 71 may include another lens to further reduce aberration, a zoom optical system, etc.

In the illustrated optical system, the optical axis CE extends in the vertical direction. Light from the object 102 is collected by the optical system 71 and an image is formed on a light receiving surface of the image sensor 72. Then, the light received by the image sensor 72 is transformed into electrical signals and subjected to processing such as color composition carried out by the operation circuit 73, so as to be displayed as an image on an appropriate display means connected.

Conventionally, in some known image sensors for generating color images, color filters of green, red and blue are arranged on pixels based on a specific rule such as in a Bayer pattern, and a color image is obtained by performing operation on adjacent pixels.

To obtain such color images, it was common to use an optical system including at least 2 to 3 aspherical lenses arranged on its optical axis. This is because it is difficult to obtain a color image with a high resolution with a single aspherical lens as a conventional aspherical lens cannot overcome a chromatic aberration (i.e., variation in focusing characteristics depending on the wavelength).

In contrast, it is possible for the imaging device 100 of the second embodiment to obtain a color image with a high resolution with a single lens because the imaging device 100 employs the optical system 71 composed of a single lens that has not only a refractive effect but also a diffractive effect.

Therefore, it is possible to make the imaging device 100 of the second embodiment thinner and smaller. Further, since it is possible to reduce the number of lenses in the optical system 71, an alignment process for the lens can be simplified and this contributes to efficient and economical production of the imaging device 100.

It is to be noted that the imaging device 100 composed of a single lens is explained in the second embodiment, but the imaging device may include the diffractive optical element of the present invention as a part of an optical system composed of a plurality of lenses. This can reduce the number of lenses, and thus, is useful.

It is also proposed recently to form a diffraction grating 4 of an ordinary shape on a surface of an imaging lens system composed of a plurality of lenses to reduce a chromatic aberration. In such a case, the number of diffraction zones is kept small to prevent undesired diffracted light from causing flares and ghosts. However, it is useful to incorporate the diffractive optical element according to the present invention in such a system because the optical element contributes to preventing flares and ghosts when an object to be imaged has brightness higher than that of its periphery.

Further, in the second embodiment, the imaging device 100 composed of one pair of the lens and the image sensor 72 was explained as an example, but the imaging device 100 may be embodied as a compound eye type imaging device which includes a plurality of pairs arranged in parallel. In such a case, an operation circuit 73 which can perform image synthesis of a plurality of images may be used.

### Third Embodiment

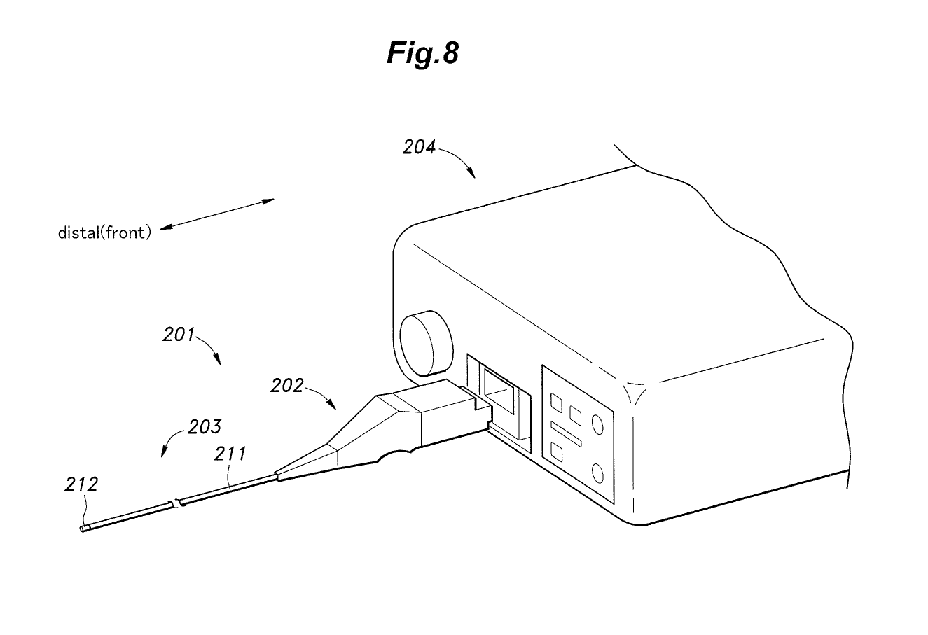

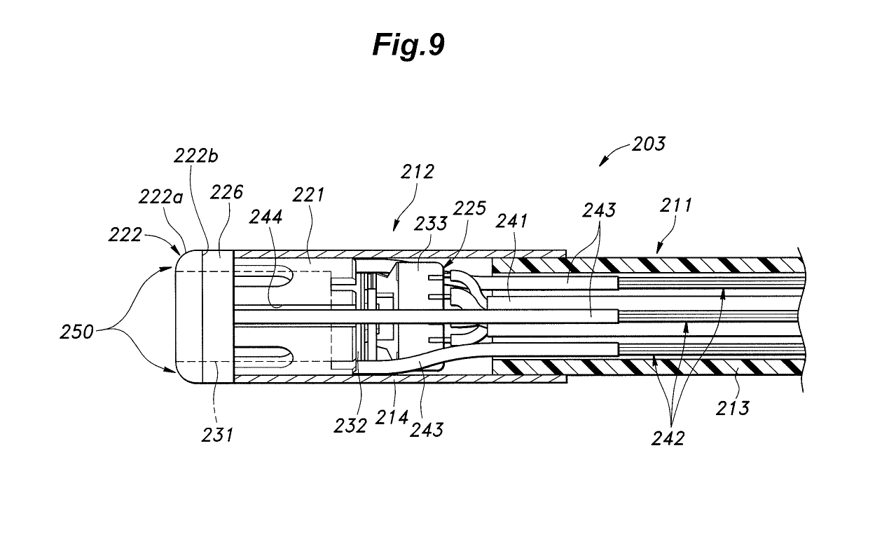

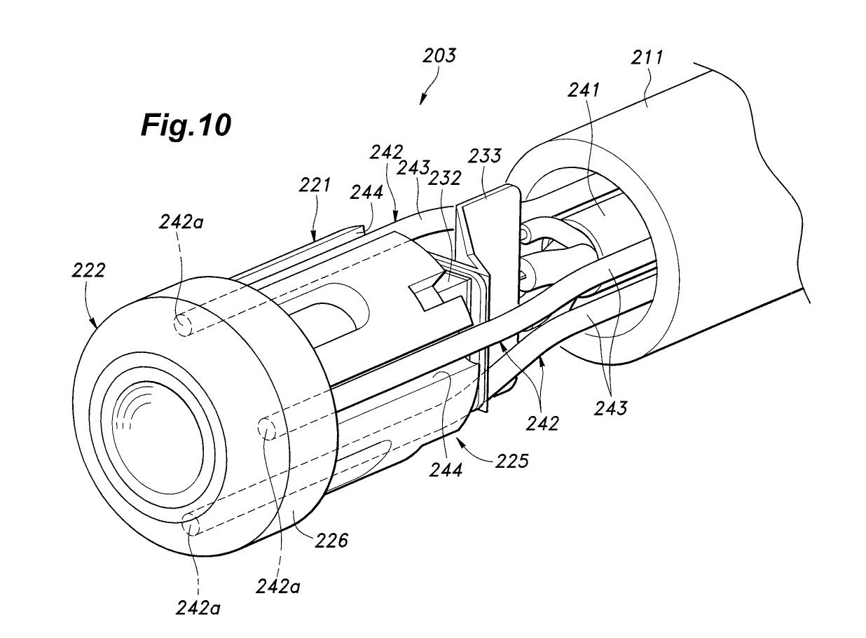

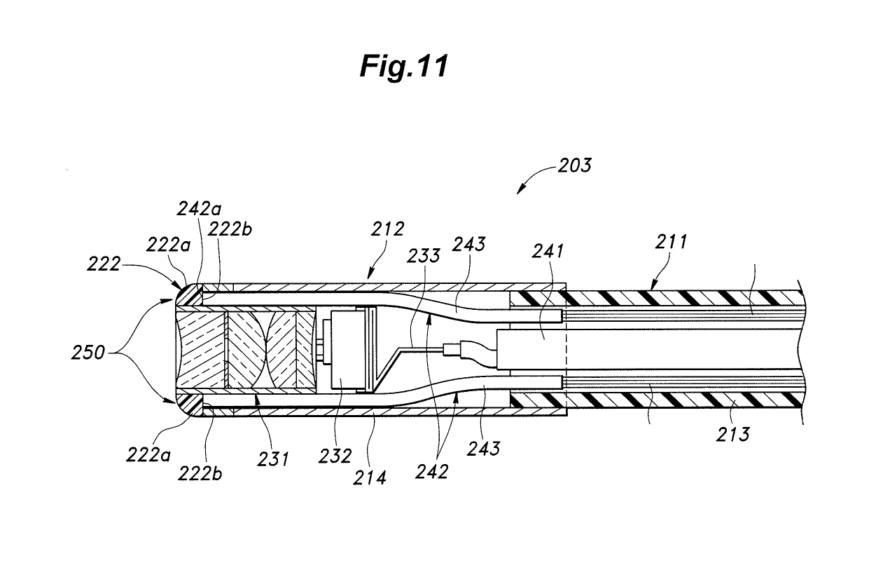

FIG. 8 is an overall structural view of an endoscope including an illuminating device of the third embodiment of the present invention. FIGS. 9 and 10 are a side view and a perspective view showing an internal structure of a distal end portion of an insertion portion of the endoscope, respectively. FIG. 11 is a cross sectional view of the distal end portion of the insertion portion of the endoscope. FIG. 9 shows the internal structure with an outer cylinder of the endoscope being cutaway, while FIG. 10 shows the internal structure with a part of the outer cylinder being removed. It is to be noted that the third embodiment is similar to the first embodiment and its variation except for otherwise noted in the following description.

As shown in FIG. 8, an endoscope 201 is a flexible endoscope for medical use, and is mainly composed of a main body portion 202 which includes a built-in light source for illumination (not shown), etc. and an insertion portion 203 which extends distally from the main body portion 202 and which is to be inserted into an interior of an object to be observed. The endoscope can receive power from a video processor 204 having known functions and transmit and receive various signals (video signals, control signals, etc.) to and from the video processor 204. The insertion portion 203 has a circular cross section with a small diameter (in the present example, about 1.8 mm) and includes a flexible portion 211 having a proximal end connected to the main body portion 202 and a rigid portion 212 having high rigidity and connected to the distal end of the flexible portion 211 to form a distal tip end.

As shown in FIGS. 9 and 10, in a distal end portion of the endoscope 201, a distal end of a flexible outer cylinder 213 is fitted into a proximal opening of a rigid outer cylinder 214. An imaging unit holder 221 is fitted into a distal portion of the rigid outer cylinder 214. A circular distal end cover (diffractive optical element) 222 made of a light-transmissive material (optical material) is attached to a distal side of the imaging unit holder 221 via a lens unit 231 described later. The distal side of the imaging unit holder 221 protrudes distally from the rigid outer cylinder 214 and a fixing ring 226 is fitted on an outer circumference of the protruding portion. The fixing ring 226 is securely attached to a distal end surface of the rigid outer cylinder 214 with the fixing ring 226 fitted on the outer circumference of the imaging unit holder 221.

An imaging unit 225 is provided for taking an image of an observed portion. The imaging unit 225 includes a lens unit 231 which constitutes an objective optical system, an image sensor 232 disposed on a proximal side of the lens unit 231 such that the light passing through the lens is focused on a light receiving surface thereof and a flat flexible cable 233 which is folded and connected to a proximal side of the image sensor 232. The proximal side of the lens unit 231 is fitted into the imaging unit holder 221.

As shown in FIG. 11, the distal end cover 222 includes a distal front surface 222a defining a round chamfer of the insertion portion 203 and a back surface 222b which is located behind the front surface 222a (on a side closer to the rigid outer cylinder 214). The front surface 222a is formed as an annular chamfered surface. The back surface 222b is formed as an annular flat surface which is perpendicular to an axis of the insertion portion 203 and which is connected to an outer peripheral edge of the front surface 222a.

A proximal portion of the flexible cable 233 is connected with a distal end of a cable 241 for power supply and signal transmission (in the present example, a four-core coaxial cable). The cable 241 is used to transmit electric power and various signals between the imaging unit 225 and the main body portion 202 (refer to FIG. 8).

The endoscope 201 is also provided with an illuminating device 250 for illuminating an observed object. The illuminating device 250 is mainly composed of a light source (in the present example, a white light LED) disposed in the main body portion 202 described above, a plurality (four in the present example) of light transmission cables 242 (optical transmission lines) which transmit light from the light source to the distal end of the insertion portion 203 and the distal end cover 222 which diffuses light emitted from the light transmission cables 242. Each light transmission cable 242 includes a bundle of optical fibers F having small diameters. A distal end of each light transmission cable 242 is covered with a metal tube 243 and is held by a holding groove 244 provided on an outer circumference of the imaging unit holder 221 (refer to FIG. 10). An exit end 242a of each light transmission cable 242 may be disposed to oppose the back surface 222b of the distal end cover 222. However, the exit end 242a is embedded in the distal end cover 222 in the present example (More specifically, silicone resin material which constitutes a later-described second layer 252 is filled up to a distal side of the metal tube 243 and the holding groove 244.). When light is emitted from the exit end 242a at a predetermined output angle (in the present example, 120°), it passes through the distal end cover 222 which functions as an illumination lens and is emitted in a distal direction of the insertion portion 203 from the front surface 222a which is provided with a round chamfer.

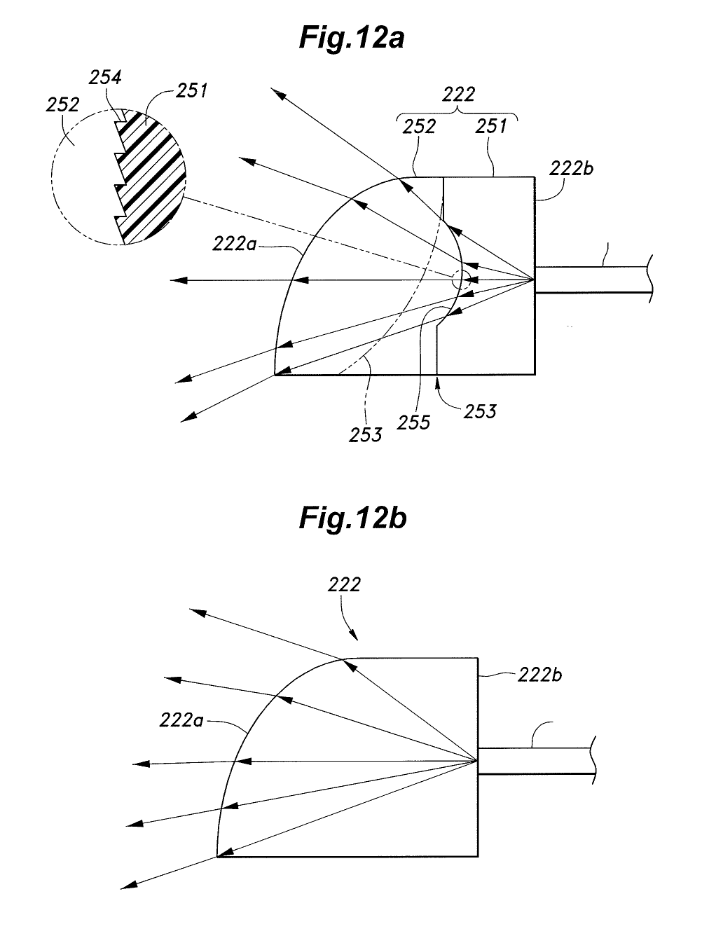

FIG. 12 is an explanatory view showing a mode of illumination provided by an endoscope and shows a schematic cross section of the distal end cover 222. FIG. 12A shows an example in which, in the distal end cover 222, a diffraction grating (a blazed diffraction grating) 254 is formed on an interface 253 between a first layer 251 made of a dendrimer material and a second layer 252 made of a silicone resin material. FIG. 12B shows a comparative example in which the distal end cover 222 is formed only of a silicone resin material (without a diffraction grating).

In the comparative example shown in FIG. 12B, light emitted from the optical fiber F in a distal direction at a predetermined output angle enters the distal end cover 222 through the back surface 222b thereof and tends to concentrate toward the central axis of the insertion portion 203 by refraction at the front surface 222a provided with a round chamfer. In other words, the distal end cover 222 functions as a convex lens. Therefore, an illumination area of the endoscope 201 may not be able to cover the whole area of an imaging range of the image sensor 232, causing an unobservable area to be created around the illumination area.

As shown in FIG. 12A, in the illuminating device 250, a first layer 251, which generally corresponds to the base member 2 in the first embodiment, constitutes an annular back portion (incident portion) of the distal end cover 222 which includes the back surface 222b. In addition, a second layer 252, which generally corresponds to the protective film 3 in the first embodiment, constitutes an annular front portion (exit portion) of the distal end cover 222 which includes the front surface 222a. The interface 253 is formed by an annular surface perpendicular to an optical axis of the optical fiber F and is provided with an annular recess 255 at a radially middle portion which faces the light transmission cable 242. The annular recess 255 has a circular surface which is concave toward a proximal direction (toward the light transmission cable 242).

Light from the optical fiber F which enters the distal end cover 222 through the back surface 222b diffuses to spread radially due to the effects of the annular recess 255 and the diffraction grating 254 at the interface 253 between the first layer 251 and the second layer 252. In other words, the interface 253 (especially the annular recess 255) of the distal end cover 222 functions as a concave lens, whereby an illumination area of the endoscope 201 expands outwardly in comparison to the case shown in FIG. 12B, decreasing unobservable area in an imaging range. Thus, in the structure in which the exit end 242a of the light transmission cable 242 (refer to FIG. 11) is located behind the round chamfered surface (on a side of the back surface) of the distal end of the insertion portion such that the light is emitted from the round chamfered surface, it is possible to prevent the light emitted from the round chamfered surface from being biased toward the center of the endoscope, whereby decrease of the illumination area (observed area) is avoided. In addition, color aberration due to diffraction is corrected and a wide range illumination with good white chromaticity is realized.

It is to be noted that the shape and arrangement of the interface 253 in the distal end cover 222 are not limited to those shown in FIG. 12A, and various modifications are possible. For example, the entirety of the interface 253 may be configured to be arc-shaped in its cross section as shown by a two-dot chain line in FIG. 12A. Similarly, various modifications may be made to the structure of the diffraction grating 254.

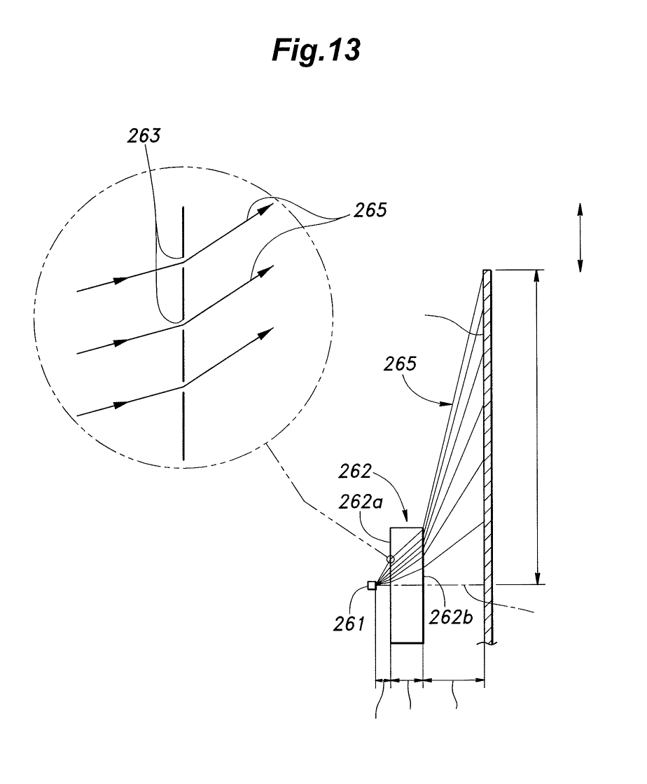

FIG. 13 is an explanatory view showing an example of diffusing effect of illumination light by diffraction. This example shows a case where white light from an LED element 261 is illuminated onto a screen surface S via a diffusing lens (diffractive optical element) 262 (only an upper side of an optical axis C). The diffusing lens 262 includes a flat incident surface (diffraction surface) 262a and a flat exit surface 262b which are disposed to be parallel to each other. A diffraction grating 263 is provided annularly on the incident surface 262a with a predetermined pitch (in the present example, 17 μm). A distance L2 between the incident surface 262a and the exit surface 262b (thickness of the diffusing lens 262) is set to be 10 mm. A distance L1 between the LED element 261 and the incident surface 262a of the diffusing lens 262 is set to be 5 mm. A distance L3 between the exit surface 262b of the diffusing lens 262 and the screen surface S is set to be 20 mm.

Light 265 emitted from the LED element 261 exhibits a Lambertian light intensity distribution and spreads outwardly (in the present example, upwardly on the screen surface S) due to diffusion caused by the diffusing lens 262 (especially, due to diffraction at the incident surface 262a). This results in a diffusion angle on the screen surface S of about 75 degrees and a distance L4 between the center of the screen surface S (the position of the optical axis of the LED element 261) and the upper boundary of illumination area of about 100 mm. It is to be noted that though the diffraction grating 263 diffracts light at varying diffraction angles depending on the wavelength of light 265, uniform and wide-area illumination can be achieved by forming the diffusing lens 262 of a silsesquioxane resin material or a dendrimer material and a silicone resin material as described above.

Description of the concrete embodiments has been provided in the foregoing. However, as can be easily understood by those skilled in the art, the present invention is not limited to the foregoing embodiments and modified examples, and may be carried out with a wide variety of modifications. The entire contents of the base application on which the priority under the Paris Convention is claimed and the entire contents of the prior art references mentioned in the present application are incorporated herein by reference.

### INDUSTRIAL APPLICABILITY

As described above, in the diffractive optical element of the present invention, a resin material which exhibits a high refractive index and a low wavelength dispersiveness and another resin material which exhibits a low refractive index and a high wavelength dispersiveness are well balanced with each other. Further, the optical element of the present invention is highly workable and exhibits high heat resistance and high endurance against temperature changes. Thus, it is possible to employ the optical element of the present invention as a lens for a camera, or in a device such as a camera module including a solid-state image sensor, a document camera, an omnidirectional camera (a surveillance camera), a portable phone, an endoscope, etc.

### GLOSSARY

1, 21 convex lens (diffractive optical element)
2, 12, 22, 32 base member
3, 13, 23, 33 protective film
4, 14, 24, 34 diffraction grating
11, 31 concave lens (diffractive optical element)
71 optical system
72 image sensor (image pickup element)
73 operation circuit
100 imaging device
103 camera unit
201 endoscope
222 distal end cover (diffractive optical element)
250 illuminating device

1. A diffractive optical element, comprising:
a base member including a diffraction grating formed on a surface thereof; and
a protective film provided on the surface of the base member where the diffraction grating is formed;
wherein the base member is composed of a silsesquioxane resin material or a dendrimer material which has a first refractive index and a first Abbe number; and
wherein the protective film is composed of a silicone resin material which has a second refractive index smaller than the first refractive index and a second Abbe number smaller than the first Abbe number.

2. A diffractive optical element, comprising:
a base member including a diffraction grating formed on a surface thereof; and
a protective film provided on the surface of the base member where the diffraction grating is formed;
wherein the protective film is composed of a silsesquioxane resin material or a dendrimer material which has a first refractive index and a first Abbe number; and
wherein the base member is composed of a silicone resin material which has a second refractive index smaller than the first refractive index and a second Abbe number smaller than the first Abbe number.

3. A diffractive optical element, comprising:
a base member including a diffraction grating formed on a surface thereof, the base member being composed of a first material having a refractive index n1; and
a protective film composed of a second material having a refractive index n2;
wherein one of the first and second materials is a silicone resin material and the other is a silsesquioxane resin material or a dendrimer material;
wherein a combination of the refractive indices n1 and n2 is selected such that a first order diffraction efficiency (m=1) calculated by an equation for calculating a diffraction efficiency ηm(λ) is 80% or more for light having a wavelength of 400-700 nm and a depth of the diffraction grating is 30 μm or less.

4. The diffractive optical element according to claim 1, wherein the silsesquioxane resin material or dendrimer material has a refractive index nd equal to about 1.52 and an Abbe number equal to about 54 and the silicone resin material has a refractive index nd equal to about 1.50 and an Abbe number equal to 34.7.

5. An imaging device including the diffractive optical element according to claim 1.

6. An illuminating device including the diffractive optical element according to claim 1.
